(19) United States
(12) Patent Application Publication
(10) Pub. No.: US 2009/0286213 A1
(43) Pub. Date: Nov. 19, 2009

(54) UNDISTURBED SPEECH GENERATION FOR SPEECH TESTING AND THERAPY

(75) Inventors: Gerd Lanfermann, Aachen (DE); Richard Daniel Willmann, Aachen (DE); Claudia Hannelore Igney, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/514,586

(22) PCT Filed: Nov. 9, 2007
(86) PCT No.: PCT/IB07/54555

§ 371 Date: May 13, 2009

(30) Foreign Application Priority Data
Nov. 15, 2006 (EP) 06124125.3

(51) Int. Cl. G09B 5/02; G09B 19/04

(52) U.S. Cl. 434/169; 434/320

(57) ABSTRACT

Speech analysis system with a system for undisturbed speech generation of a person and to a method for analysing a speech generation of a person. The speech analysis system allows for an undisturbed speech generation by the person. The system first writes out the test sentence, clears it and shows afterwards a sequence of visual clues to the person in order to remind him of the correct wording. The person is reminded of the sentence and repeats it exactly but without any influence through letters. The method provides visual clues that remind the person of the exact sentence, without influencing his pronunciation.

The present invention relates to a speech analysis system with a system for undisturbed speech generation of a person and to a method for analysing a speech generation of a person, in particular for speech therapy of dysarthric patients.

Dysarthria is a speech disorder, the possible reasons of which are numerous, like diseases, such as ALS, Parkinson's disease and cerebral palsy. Dysarthria can also be a symptom shown by stroke victims or traumatic brain injury survivors. Stroke is the third leading cause of death in the western world and the most prominent cause for permanent disabilities. The incidence in the United States is 700.000 per year, with a tendency to increase, according to the aging of society. Dysarthria refers to a group of speech disorders resulting from weakness, slowness, or incoordination of the speech mechanism due to damage to any of a variety of points in the nervous system. Dysarthria may involve disorders to some or all of the basic speech processes, like respiration phonation, resonance, articulation, and prosody. Dysarthria is a disorder of speech production not language, like for example, use of vocabulary and/or grammar. The muscles and organs which are involved in speech generation are as well intact. The articulation problems that dysarthria causes can be treated in a speech therapy by strengthening the speech musculature. Devices that make coping with dysarthria easier include speech synthesis software.

Acoustic methods have progressed to the point that an acoustic typology of dysarthric speech disorders can be constructed from a parametric assessment of the speech subsystems, e.g., phonation, nasal resonance, vowel articulation, consonant articulation, intonation, and rhythm. The results of this analysis can be interpreted in respect to global functions in speech, e.g., voice quality, intelligibility, and prosody. To conduct a proper speech analysis, the patient has to more or less exactly repeat a requested sentence. The speech quality of a dysarthric patient is different depending on whether the patient reads a sentence, repeats a sentence or pronounces an object that he thinks of. A speech analysis test, which merely asks a patient to repeat a written sentence, will fail to benchmark the speech generation, which the patient uses, for example in a conversation.

In US 2002/0099546 A1, a method of speech therapy using symbols representative of words is proposed. It is a drawback, that the response of the patient is too short for meaningful analysis. It is necessary to have short sentences or ellipses of five or six words in order to conduct a proper analysis. Further, the meaning of a image can be different from patient to patient. The image of a car might be described as “car”, “automobile” or the by the car's brand. While such a response may be acceptable for manual speech testing, an automated speech analysis will only show proper performance if the answer of the patient is known.

It is therefor an object of the present invention to provide a method for analysing a speech generation of a person, which enables the persons to more exactly repeat a test sentence.

The above objective is accomplished by a method for analysing a speech generation of a person, the method comprising the steps of:
displaying a test sentence to the person;
subsequently providing a non-textual information to the person, the non-textual information being related to at least one keyword of the test sentence;
recording and/or analysing the test sentence as the test sentence is articulated by the person.

It is an advantage of the method according to the invention, that for speech therapies, e.g. after stroke, the patient or person is enabled, to more or less exactly repeat a requested sentence, without involuntarily influencing him towards the correct pronunciation, which is not wanted in view of a proper speech analysis. As long as the test sentence is displayed to the person, the person's speech is not analysed. The non-textual information related to keywords of the test sentence is given as a clue in order to remind the person of the sentence. The person repeats the memorized test sentence, substantially without departing from the requested test sentence, and thus the speech quality will be more authentic, since the person cannot rely on written words, for example.

The test sentence in the sense of this invention is any sentence or ellipsis of preferably five or six words in length. In the grammar of a sentence, an ellipsis or elliptical clause (a form of elliptical construction) is a clause in which some words have been omitted. Because of the logic or pattern of the entire sentence, it is easy to infer what the missing words are. In a preferred embodiment of the invention, the sentence is chosen from a first database of sentences, for example by randomly or pseudo-randomly choosing one of the sentences in the first database. However, it is as well feasible, that a therapist elects or provides any sentence as the test sentence.

The step of displaying the test sentence to the person is meant to incorporate any way of making the person aware of the test sentence. It is important that the person knows the exact sentence which shall be repeated. Preferably, the person reads the test sentence, but, for example in case of a visually disabled person, any kind of haptic display, such as embossed printing, is feasible, as well as reading out the sentence to the person.

The non-textual information, in the sense of this invention, is any kind of information which is not in the form of a literal representation, i.e. no written text, where written text is meant to enclose embossed printing nor any other alphabetic code. Preferably the non-textual information is presented as images or symbols, which do not represent single alphabetic letters.

According to the invention, the non-textual information is related to at least one keyword of the test sentence. Keywords are to be understood as those words of the test sentence which substantially sum up the meaning of the sentence, for example one or more nouns, main verbs and sometimes the adverbs or adjectives. The relation of the non-textual information, in the sense of the invention, means that the non-textual information is suitable to remind the person of the keyword the non-textual information relates to. Thus the person under test is given clues by displaying the non-textual information, which help to remember the exact test sentence. The person skilled in the art understands, that it is not required to exactly express the test sentence by way of the non-textual information. A few clues will usually suffice to enable the person to repeat the exact test sentence.

Preferably, the test sentence is displayed to the person on a screen, i.e. as written text. The display of the test sentenced is advantageously controllable by using a screen, which is, for example, connected to a computer device. The time for displaying the test sentence may be preset to a certain interval. The test sentence is then cleared from the screen.

The non-textual information, in particular one or more images, is preferably displayed to the person on a screen. Advantageously, the display of the non-textual information is possible on the same screen on which the test sentence had been displayed before. The non-textual information is displayed while the person articulates the test sentence.

The non-textual information is preferably obtained from a second database. In the second database, for each non-textual information, at least one keyword is stored which the non-textual information is related to. The second database advantageously allows to look up the keywords of the test sentence and is adapted to output the related non-textual information. The keywords in the test sentence are preferably recognised which may advantageously be performed automatically, for example by a computer system.

The recognition of the keywords is preferably performed by comparing any word of the test sentence to the keywords in the second database. The person skilled in the art understands that the recognition of keywords may be performed for any sentence. If, however, the test sentence is chosen from the first database, the first second databases may advantageously comprise cross references between the keywords of the sentences in the first database and the appropriate non-textual information in the second database.

In a further preferred embodiment of the method according to the invention, a time period between the steps of displaying the test sentence and providing the non-textual information is adaptable, for example by an operator or by the person under test or, preferably, automatically. The person skilled in the art understands that the order of time of the method steps may be adapted, i.e. the duration of the time period of displaying the test sentence, the time period between clearing the screen and providing the non-textual information, and/or the time period for providing the non-textual information.

It is also preferred to adapt parameters of the non-textual information, which may be one or more of at least a colour, a number and a size of images or symbols which form the non-textual information. For example, only one keyword or only the most important keywords are recognised and displayed in the non-textual information, in particular, if the person has easily remembered the exact test sentences, previously. It is thus particularly preferred to adapt the time period between the steps of displaying the test sentence and providing the non-textual information and/or to adapt the parameters of the non-textual information depending on an error rate of the articulated test sentence, i.e. depending upon the quality of the answer of the person under test. This embodiment advantageously allows an adaptation of the method regarding the progress of a therapy. Further, the inventive method may advantageously be used for training the short-term memory of a person.

The test sentence is repeated by the person and, according to the invention, the repeated test sentence is recorded and/or analysed. Preferably the step of recording and/or analysing the test sentence comprises an automated speech analysis. The automated speech analysis advantageously allows a benchmarking of dysarthric speech generation, irrespective of subjective intelligibility of the person's speech for a therapist. Automated speech analysis comprises a process wherein a microprocessor-based system, typically a computer with sound processing hardware and speech recognition software, which responds in predictable way to the input of speech.

Another object of the present invention is a system for undisturbed speech generation of a person, the system comprising a first database of sentences and a second database of non-textual information, the non-textual information being related to keywords, the system further comprising a display device, the display device being adapted to first display a test sentence chosen from the sentences of the first database, and to subsequently display the non-textual information from the second database, which is related to the keywords of the test sentence.

The inventive system for undisturbed speech generation allows the person to generate speech, i.e. to articulate the test sentence without being influenced by the letters towards the correct pronunciation, which is unwanted in test setting. However, if the person repeats a memorized sentence, the speech quality will be more authentic, since the person cannot rely on the written words.

The first database of sentences and the second database of non-textual information is preferably stored on a storage device. The inventive system preferably comprises a microcontroller, the microcontroller controlling the display of the test sentence and subsequent display of the non-textual information on the display device. Advantageously, the microcontroller controls the display device to display a test sentence from the first database, for the person to see, with no analysis performed yet. The test sentence is then cleared from the display device. The microcontroller is preferably adapted to recognise the keywords in the test sentence and to chose the non-textual information related to the keywords for display on the display device. The system microcontroller thus determines a proper non-textual information, for example a sequence of images, which illustrate keywords of the sentence. The non-textual information is shown to the person, who is then asked to recall the sentence from his memory and say it aloud. The system provides visual clues that remind the user of the exact sentence, without influencing his pronunciation.

Another object of the present invention is a speech analysis system comprising a system for undisturbed speech generation of a person as described in here before, the speech analysis system further comprising means for recording and/or analysing the test sentence as the test sentence is articulated by the person. The analysis of the speech is enhanced as the generated speech is not disturbed or influenced due to the person reading the test sentence. Preferably the means for analysing the test sentence comprises an automated speech analysis device, in particular a microprocessor-based system, typically a computer with sound processing hardware and speech recognition software. Automated speech analysis advantageously allows a benchmarking of dysarthric speech generation, irrespective of subjective intelligibility of the person's speech for a therapist.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

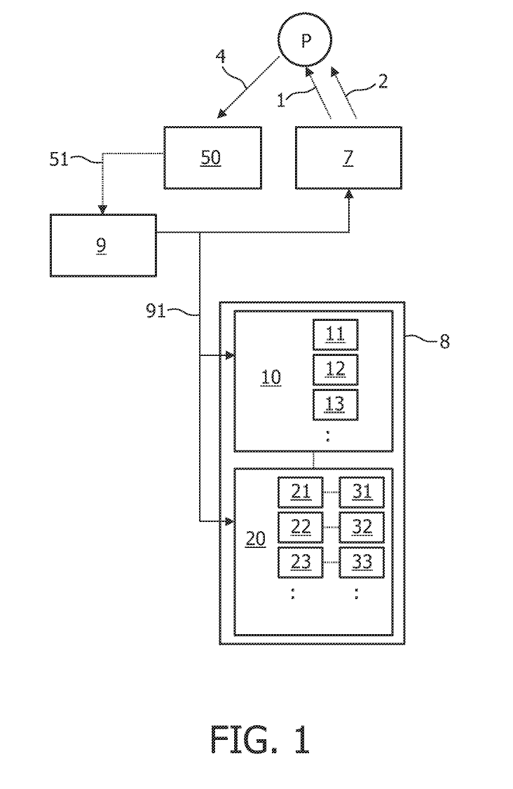

FIG. 1 schematically illustrates a speech analysis system comprising a system for undisturbed speech generation of a person, according to the present invention.

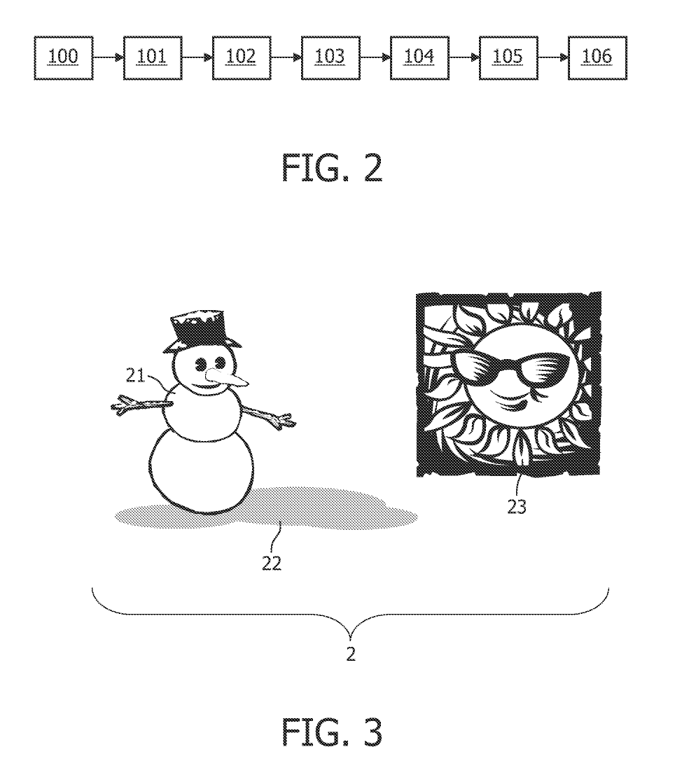

FIG. 2 illustrate the method according to the present invention in a flow diagram.

FIG. 3 shows a non-textual information generated by the system for undisturbed speech generation of a person, according to the present invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1, a speech analysis system comprising a system for undisturbed speech generation of a person P, according to the present invention, is schematically illustrated. The depicted embodiment comprises a microcontroller 9 which accesses two databases, a first database 10 of sentences 11, 12, 13 and a second database 20, wherein parts of non-textual information 21, 22, 23 and related keywords 31, 32, 33 are stored. Both databases are preferably stored on a storage device 8, in particular a hard disk drive or any other suitable memory medium for huge amounts of data. The parts of non-textual information 21, 22, 23 are preferably images and/or symbols, but no alphabetical letters. The correlation of the keywords 31, 32, 33 to the non-textual information parts 21, 22, 23 is such, that the textual information or image or symbol depicts or illustrates the meaning of the respective keyword in any way which is illustrated by dotted lines. As an example, keyword 31 may be “snowman” and image 21 is a painted picture of a snowman, see also FIG. 3. The person skilled in the art understands that the first and second database 10, 20 may as well be linked in such a way that a correlation between the sentences 11, 12, 13 and their respective keywords is established.

The access of the microcontroller 9 to the databases 10, 20 is illustrated by arrow 91. The microcontroller also controls a display device 7 which may be any commercially available computer monitor or TV screen. On the display device 7, the sentences 11, 12, 13 from the first database 10 are displayable in written text. The microcontroller 9 or an operator (not depicted) chooses a sentence which is the test sentence 1 to be displayed on the display device 7, so the person P who is watching the display device 7 can read the test sentence, which is illustrated by arrow 1. After the test sentence 1 has been cleared from the display device 7, a non-textual information 2 is displayed on the same display device 7 to the person P which is depicted by arrow 2. The time period between clearing the display device 7 and displaying the non-textual information 2 is preferably adapted to the quality of the previous answers of the person P, i.e. depending upon an error rate. The keywords 11, 12, 13 from the second database 20 which appear in the test sentence 1 are recognised and a non-textual information 2 is composed from one or more of the images and/or symbols 21, 22, 23 from the second database 20, which are related to the recognised keywords.

The non textual information 2 serves the person P as a reminder of the test sentence 1. The person P is thus able to repeat the test sentence 1 and articulate it without reading the test sentence 1, which is illustrated by arrow 4. The non-textual information 2 provides visual clues that remind the person P of the exact test sentence 1, without influencing his pronunciation.

The spoken test sentence 4 may then, for example assessed by a therapist who is just listening. Further, the system for undisturbed speech generation of the person P, together with a means 50 for recording and/or analysing the test sentence 1 as the test sentence is articulated 4 by the person P, forms a speech analysis system. In a preferred embodiment the means 50 for recording and/or analysing the test sentence comprises an automated speech analysis device, in particular a microprocessor-based system, typically a computer with sound processing hardware and speech recognition software. Automated speech analysis advantageously allows a benchmarking of dysarthric speech generation, irrespective of subjective intelligibility of the person's speech for a therapist. In the depicted embodiment the means 50 is not stand-alone speech analysis device, but uses microcontroller 9 which is illustrated by dotted arrow 51.

In FIG. 2, a simplified workflow of a method for analysing a speech generation of a person P by the system of FIG. 1 is illustrated. The reference signs refer to both FIGS. 1 and 2. Step 100 is to choose a test sentence 1 from the database 10. In step 101, the test sentence 1 is displayed on the display device or screen 7. In step 102, the screen is cleared. Steps 103 and 104 may as well be executed at the same time as steps 101 and 102. Step 103 comprises the recognition of keywords 31, 32, 33 in the test sentence 1 and in step 104 the non-textual information 2 is composed from the non-textual information parts 21, 22, 23 which refer to the keywords 31, 32, 33 in the second database 20. After an adaptable period of time, in step 105, the non-textual information 2 is displayed on the screen 7 and then, step 106, the person P is asked to repeat the test sentence 1. According to the quality of the answer of the person P, the time period between step 102 and step 105 is adapted. The speech generation of the person P is undisturbed by the influence of written text and the non-textual information 2 reminds the person of the exact test sentence 1.

In FIG. 3, an example of a non-textual information 2 is given. The test sentence 1 which the non-textual information 2 shall remind the person of, may be, for example: “The snowman is melting in the sun.” The keywords in this sentence are, for example, snowman 31, melting 32 and sun 33, which are represented by their correlated images 21, 22, 23. Though the person would probably not recognise the test sentence 1 from the non-textual information 2 alone, i.e. if he or she had not read the test sentence 1 before, the non-textual information 2 is sufficient to remind the person of the exact test sentence 1. However, depending upon the error rate of the answers of the person, the parameters of the non-textual information are preferably adapted. The colour or size of the images may be changed or the number of images may be reduced. For example, only the snowman 21 is displayed.

1. Method for analysing a speech generation of a person (P), the method comprising the steps of:
displaying a test sentence (1) to the person (P);
subsequently providing a non-textual information (2) to the person, the non-textual information being related to at least one keyword (31, 32, 33) of the test sentence (1);
recording and/or analysing (50) the test sentence as the test sentence is articulated (4) by the person (P).

2. Method according to claim 1, wherein the test sentence (1) is chosen from a first database (10) of sentences.

3. Method according to claim 1, wherein the test sentence (1) is displayed to the person (P) as written text on a screen (7).

4. Method according to claim 1, wherein the non-textual information (2) comprises images, the images being displayed to the person on a screen (7).

5. Method according to claim 1, wherein the non-textual information (2) is obtained from a second database (20), the second database comprising at least one keyword (31, 32, 33) related to each part of non-textual information (21, 22, 23).

6. Method according to claim 1, wherein the keywords (31, 32, 33) in the test sentence (1) are recognised.

7. Method according to claim 6, wherein the identification of the keywords (31, 32, 33) is performed by comparing words of the test sentence (1) to the keywords in a second database (20).

8. Method according to claim 1, wherein a time period between the steps of displaying the test sentence (1) and providing the non-textual information (2) is adaptable.

9. Method according to claim 1, wherein parameters of the non-textual information (2) are adaptable, the parameters being one or more of at least colour, number and size of images of the non-textual information (2).

10. Method according to claim 8, wherein the time period and/or the parameters are adapted depending on an error rate of the articulated test sentence (4).

11. Method according to claim 1, wherein the step of recording and/or analysing (50) the test sentence (1) comprises an automated speech analysis.

12. System for undisturbed speech generation of a person (P), the system comprising a first database (10) of sentences (11, 12, 13) and a second database (20) of non-textual information, each part of non-textual information (21, 22, 23) being related to at least on keyword (31, 32, 33), the system further comprising a display device (7), the display device (7) being adapted to first display a test sentence (1) chosen from the sentences of the first database, and to subsequently display the non-textual information (2) from the second database, which is related to the keywords of the test sentence.

13. System according to claim 12, wherein the first database (10) of sentences and the second database (20) of non-textual information is stored on a storage device (8).

14. System according to claim 12, further comprising a microcontroller (9), the microcontroller controlling the display of the test sentence (1) and subsequent display of the non-textual information (2) on the display device (7).

15. System according to claim 12, wherein the microcontroller (9) is adapted to recognise the keywords (31, 32, 33) in the test sentence (1) and to chose the non-textual information (2) related to the keywords from the second database (20) for display on the display device (7).

16. Speech analysis system comprising a system for undisturbed speech generation of a person (P) according to claim 12, further comprising means (50) for recording and/or analysing the test sentence (1) as the test sentence is articulated (4) by the person (P).

17. Speech analysis system according to claim 16, wherein the means (50) for analysing the test sentence comprises an automated speech analysis device.
